(19) United States
(12) Patent Application Publication
(10) Pub. No.: US 2009/0160778 A1
(43) Pub. Date: Jun. 25, 2009

(54) APPARATUS, METHOD AND COMPUTER PROGRAM PRODUCT FOR USING VARIABLE NUMBERS OF TACTILE INPUTS

(75) Inventors: Juha Harri-Pekka Nurmi, Salo (FI); Kaj Juhani Saarinen, Tokyo (JP); Tero Juhani Rautanen, Turku (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/960,241

(22) Filed: Dec. 19, 2007

(51) Int. Cl. G06F 3/041

(52) U.S. Cl. 345/173

(57) ABSTRACT

An apparatus, method and computer program product are provided for using varying numbers of tactile inputs to manipulate different features of an electronic device. In particular, varying numbers of tactile inputs resulting from a user touching the electronic device touchscreen or touchpad may be used in order to adjust the speed of movement of an image displayed on the electronic device. Varying numbers of tactile inputs may likewise be used to adjust in various manners an adjustable feature represented by an icon displayed on the electronic device display screen. Finally, varying numbers of tactile inputs may further be used in order to unlock an electronic device in a secure, yet simple, manner.

### FIELD

Embodiments of the invention relate, generally, to a touch-sensitive input device and, in particular, to the use of varying numbers of tactile inputs in association with the touch-sensitive input device.

### BACKGROUND

It is becoming increasingly popular for electronic devices, and particularly portable electronic devices (e.g., cellular telephones, personal digital assistants (PDAs), laptops, pagers, etc.) to use touch-sensitive input devices for receiving user-input information. For example, many devices use touch-sensitive display screens or touchscreens. Alternatively, devices, such as laptops in particular, may use touch-sensitive input devices that are separate from the display screen, referred to as touchpads, for receiving user input. While very useful, these touchscreens and touchpads are not without their problems and issues.

For example, given the often small size of the touchscreen or touchpad, it may be difficult to manipulate objects displayed on the display screen using the touchscreen or touchpad. For example, the amount of movement of a cursor on a device display screen is typically constant with regard to the movement of a selection object on the device touchscreen or touchpad. In many instances where a touchpad is used, because of the relative size of the touchpad with respect to the display screen, it may be necessary for an individual to repeat a gesture on the touchpad a number of times in order to move the image displayed on the display screen to the desired location. A need, therefore, exists for a way to facilitate movement of images on the electronic device display screen when using a touchscreen or touchpad.

In addition, in order to adjust various features or parameters of an electronic device (e.g., the volume, brightness zoom level, etc.), it is often necessary to take several steps, which can be difficult when attempting to take those steps using a finger, stylus, pen, or other selection object. For example, in many instances, in order to adjust the volume of an electronic device, a user may be required to first select an audio icon corresponding to the electronic device volume. In response, a sub-icon may be displayed that a user must then manipulate (e.g., move left or right) in order to increase or decrease the electronic device volume). A need exists for a technique for reducing the number of steps required to be taken, as well as the number of images and sub-images required to be displayed, in order to adjust a parameter associated with the electronic device having a touchscreen or touchpad.

Yet another example of an issue that may be often faced by users of electronic devices having touchpads or touchscreens is in relation to the process for unlocking the electronic device. In many instances, in order to unlock an electronic device having a touchpad or touchscreen, a user may only be required to touch the touchscreen or touchpad once, for example, at a certain location. Because of the lack of complexity in this process, it may be easy to accidentally unlock the device. A need, therefore, exists, for a technique for unlocking an electronic device having a touchpad or touchscreen that is complex enough that a user is less likely to unlock the device accidentally, but not so complex that it becomes cumbersome.

### BRIEF SUMMARY

In general, embodiments of the present invention provide an improvement by, among other things, providing several techniques for using varying numbers of tactile inputs to manipulate different features or parameters of an electronic device (e.g., cellular telephone, personal digital assistant (PDA), personal computer (PC), laptop, pager, etc.). In particular, according to one embodiment, varying numbers of tactile inputs resulting from a user touching the electronic device touchscreen or touchpad may be used in order to adjust the speed of movement of an image displayed on the electronic device display screen. According to another embodiment, varying numbers of tactile inputs may be used to adjust in various manners an adjustable feature or parameter represented by an icon displayed on the electronic device display screen. According to yet another embodiment, varying numbers of tactile inputs may be used in order to unlock an electronic device in a secure, yet simple, manner.

In accordance with one aspect, an apparatus is provided for adjusting the speed of movement of a displayed object in relation to the number of tactile inputs used to manipulate the displayed object. In one embodiment, the apparatus may include a processor configured to: (1) cause an image to be displayed at a first display location; (2) receive one or more tactile inputs at a first touch location; (3) detect a movement of the one or more tactile inputs from the first touch location to a second touch location; (4) determine the number of tactile inputs received; and (5) translate the image displayed, such that the image is displayed at a second display location, wherein a distance between the first and second display locations is determined based at least in part on the determined number of tactile inputs received.

In accordance with another aspect, a method is provided for adjusting the speed of movement of a displayed object in relation to the number of tactile inputs used to manipulate the displayed object. In one embodiment, the method may include: (1) displaying an image at a first display location; (2) receiving one or more tactile inputs at a first touch location; (3) detecting a movement of the one or more tactile inputs from the first touch location to a second touch location; (4) determining the number of tactile inputs received; and (5) translating the image displayed, such that the image is displayed at a second display location, wherein a distance between the first and second display locations is determined based at least in part on the determined number of tactile inputs received.

According to yet another aspect, a computer program product is provided for adjusting the speed of movement of a displayed object in relation to the number of tactile inputs used to manipulate the displayed object. The computer program product contains at least one computer-readable storage medium having computer-readable program code portions stored therein. The computer-readable program code portions of one embodiment may include: (1) a first executable portion for causing an image to be displayed at a first display location; (2) a second executable portion receiving one or more tactile inputs at a first touch location; (3) a third executable portion detecting a movement of the one or more tactile inputs from the first touch location to a second touch location; (4) a fourth executable portion determining the number of tactile inputs detected; and (5) a fifth executable portion translating the image displayed, such that the image is displayed at a second display location, wherein a distance between the first and second display locations is determined based at least in part on the determined number of tactile inputs received.

In accordance with one aspect, an apparatus is provided for adjusting the speed of movement of a displayed object in relation to the number of tactile inputs used to manipulate the displayed object. In one embodiment, the apparatus may include: (1) means for causing an image to be displayed at a first display location; (2) means for receiving one or more tactile inputs at a first touch location; (3) means for detecting a movement of the one or more tactile inputs from the first touch location to a second touch location; (4) means for determining the number of tactile inputs detected; and (5) means for translating the image displayed, such that the image is displayed at a second display location, wherein a distance between the first and second display locations is determined based at least in part on the determined number of tactile inputs received.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an entity capable of operating as an electronic device in accordance with embodiments of the present invention;

FIG. 2 is a schematic block diagram of a mobile station capable of operating in accordance with an embodiment of the present invention;

FIG. 3 is a flow chart illustrating the process of adjusting the speed of movement of a displayed object in accordance with embodiments of the present invention;

FIGS. 4A-4C are block diagrams illustrating the movement of a displayed object at various speeds in accordance with embodiments of the present invention;

FIG. 5 is a flow chart illustrating the process of using multiple tactile inputs to manipulate an adjustable feature or parameter in accordance with embodiments of the present invention;

FIGS. 6A-6C are block diagrams illustrating the manipulation of an adjustable feature or parameter using varying numbers of tactile inputs in accordance with an embodiment of the present invention;

FIG. 7 is a flow chart illustrating the process of unlocking an electronic device based on a number of tactile inputs in accordance with an embodiment of the present invention; and

FIG. 8 is a block diagram illustrating the process of unlocking an electronic device in accordance with an embodiment of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide an apparatus, method and computer program product for using multiple tactile inputs to adjust various features or parameters associated with an electronic device. According to one embodiment, a user may use one or more fingers, or other selection objects, to select and move an image (e.g., cursor, icon, etc.) displayed on the electronic device display screen. The speed at which the displayed image is moved may be based on the number of fingers, or similar selection objects, used. For example, the displayed image may move across the display screen twice as fast if the user selects and moves the image using two fingers, or other selection objects, as opposed to one.

In another embodiment, the number of fingers, or other selection objects, used to select a displayed icon representing an adjustable feature or parameter of the electronic device may determine how the feature or parameter is adjusted. For example, by selecting an icon associated with the zoom level of the electronic device display screen with one finger, or other selection device, the displayed image may zoom out, while the selection with two selection objects may result in the displayed image zooming in. In yet another embodiment wherein a varying number of tactile inputs may be used to affect a different action or manipulate a specific feature, a user may define a specific number of tactile inputs and/or a location at which those tactile inputs must be received at or about the same time in order to unlock the electronic device.

### Electronic Device & Exemplary Mobile Station:

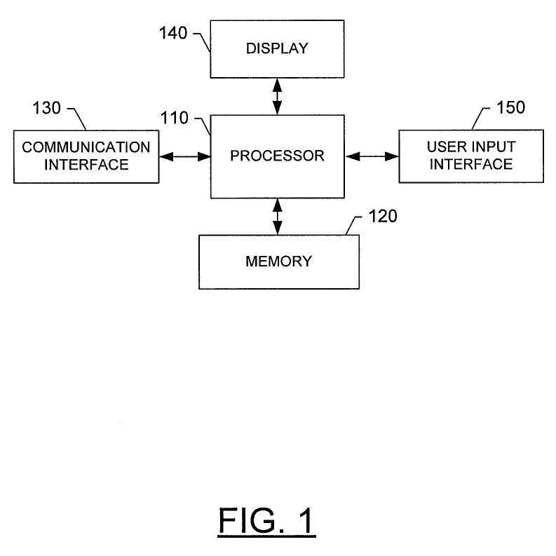

Referring now to FIG. 1, a block diagram of an entity capable of operating as an electronic device using multi-touch functionality in accordance with embodiments of the present invention is shown. The entity may include various means for performing one or more functions in accordance with embodiments of the present invention, including those more particularly shown and described herein. It should be understood, however, that one or more of the entities may include alternative means for performing one or more like functions, without departing from the spirit and scope of the present invention. As shown, the entity capable of operating as the electronic device can generally include means, such as a processor 110 for performing or controlling the various functions of the entity.

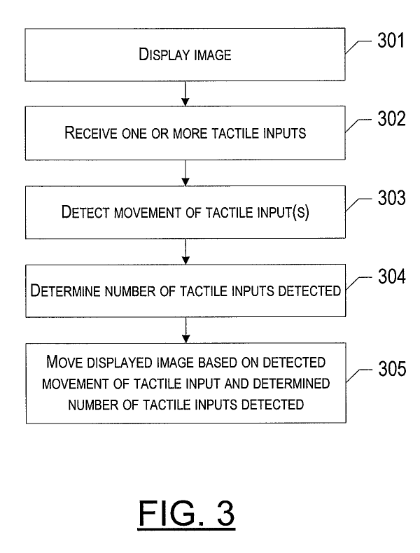

In particular, the processor 110, or similar means, may be configured to perform the processes discussed in more detail below with regard to FIGS. 3, 5 and 7. For example, the processor 110 may be configured to alter the speed of movement of a displayed image based at least in part on a number of selection objects used to select and move the image. In order to do so, the processor may be configured to display an image at a first display location on a display screen. The processor may thereafter be configured to receive one or more tactile inputs at a first touch location on a touchscreen or touchpad and to detect movement of the tactile inputs from the first touch location to a second touch location. The processor may further be configured to determine the number of tactile inputs detected, and to translate the displayed image, such that the image is displayed at a second display location, wherein the distance between the first and second display locations is based at least in part on the number of tactile inputs received.

In one embodiment, the processor is in communication with or includes memory 120, such as volatile and/or non-volatile memory that stores content, data or the like. For example, the memory 120 typically stores content transmitted from, and/or received by, the entity. Also for example, the memory 120 typically stores software applications, instructions or the like for the processor to perform steps associated with operation of the entity in accordance with embodiments of the present invention.

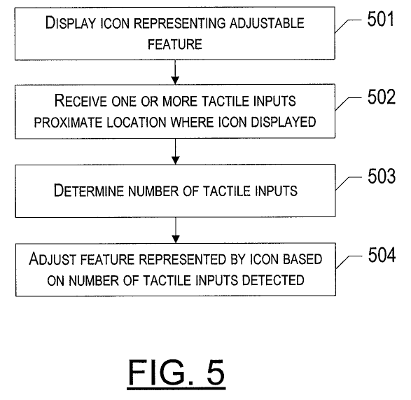

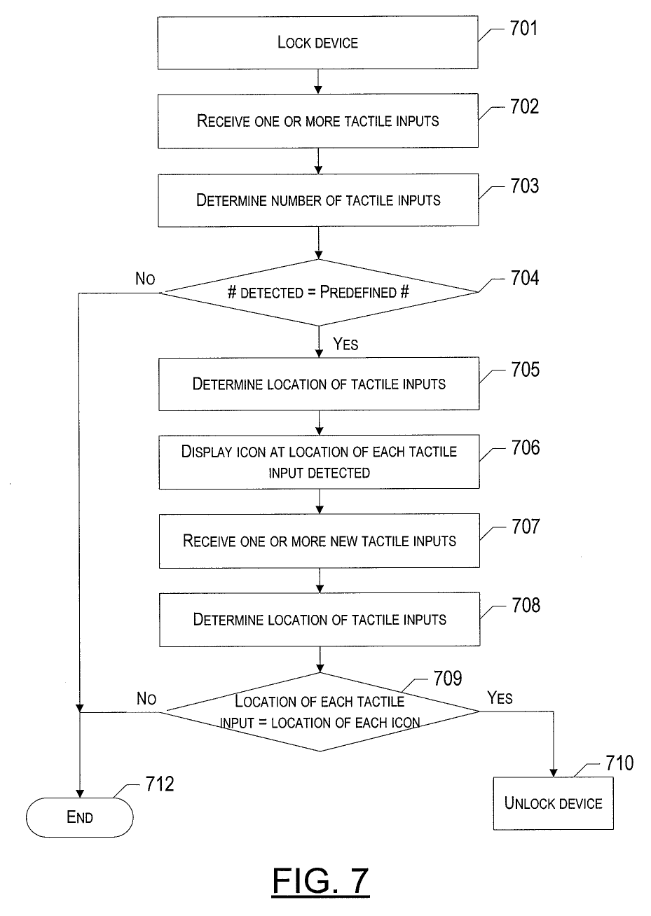

In particular, according to one embodiment, the memory may store computer program code or instructions for causing the processor to perform the operations discussed above and below with regard to altering the speed of movement of a displayed image based at least in part on a number of selection objects used to select and move the image. In addition, as discussed in more detail below with regard to FIG. 5, according to another embodiment the memory may store computer program code for causing the processor to adjust an adjustable feature associated with the electronic device in a particular manner based on a number of tactile inputs received. In a further embodiment, discussed in more detail below with regard to FIG. 7, the memory may store computer program code for causing the processor to unlock the electronic device based on the receipt of a predefined number of tactile inputs.

In addition to the memory 120, the processor 110 can also be connected to at least one interface or other means for displaying, transmitting and/or receiving data, content or the like. In this regard, the interface(s) can include at least one communication interface 130 or other means for transmitting and/or receiving data, content or the like, as well as at least one user interface that can include a display 140 and/or a user input interface 150. The user input interface, in turn, can comprise any of a number of devices allowing the entity to receive data from a user, such as a keypad, a touch-sensitive input device (e.g., touchscreen or touchpad), a joystick or other input device.

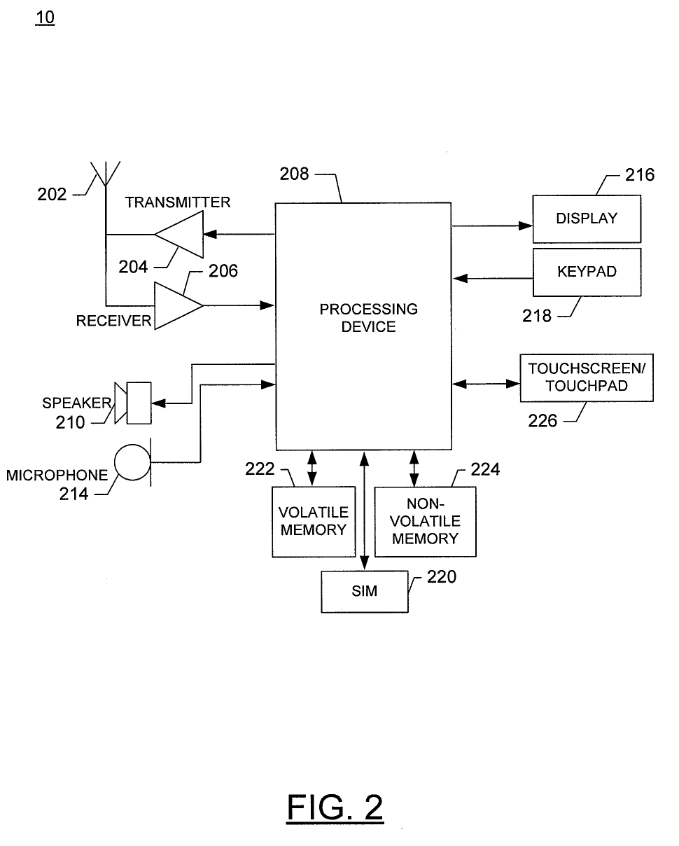

Reference is now made to FIG. 2, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with embodiments of the present invention, including those more particularly shown and described herein. It should be understood, however, that the mobile station may include alternative means for performing one or more like functions, without departing from the spirit and scope of the present invention. More particularly, for example, as shown in FIG. 2, in addition to an antenna 202, the mobile station 10 includes a transmitter 204, a receiver 206, and an apparatus that includes means, such as a processing device 208, e.g., a processor, controller or the like, that provides signals to and receives signals from the transmitter 204 and receiver 206, respectively, and that performs the various other functions described below including, for example, the functions relating to adjusting the speed of movement of a displayed image, adjusting an adjustable feature, and unlocking the mobile station, all using a varying number of tactile inputs.

As discussed in more detail below with regard to FIG. 3, in one embodiment, the processor 208 may be configured to display an image at a first display location on a display screen (e.g., a touchscreen). The processor may thereafter be configured to receive one or more tactile inputs at a first touch location on a touchscreen or touchpad and to detect movement of the tactile inputs from the first touch location to a second touch location. The processor may further be configured to determine the number of tactile inputs detected, and to translate the displayed image, such that the image is displayed at a second display location, wherein the distance between the first and second display locations is based at least in part on the number of tactile inputs received.

In addition, as discussed in more detail below with regard to FIG. 5, according to another embodiment the processor may be configured to adjust an adjustable feature based on a number of tactile inputs received. In a further embodiment, as discussed in more detail below with regard to FIG. 7, the processor may be configured to unlock the electronic device based on the receipt of a predefined number of tactile inputs.

As one of ordinary skill in the art would recognize, the signals provided to and received from the transmitter 204 and receiver 206, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5 G and/or third-generation (3G) communication protocols or the like. Further, for example, the mobile station can be capable of operating in accordance with any of a number of different wireless networking techniques, including Bluetooth, IEEE 802.11 WLAN (or Wi-Fi(g), IEEE 802.16 WiMAX, ultra wideband (UWB), and the like.

It is understood that the processing device 208, such as a processor, controller or other computing device, may include the circuitry required for implementing the video, audio, and logic functions of the mobile station and may be capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. Further, the processing device 208 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a microphone 214, a display 216, all of which are coupled to the controller 208. The user input interface, which allows the mobile device to receive data, can comprise any of a number of devices allowing the mobile device to receive data, such as a keypad 218, a touch-sensitive input device, such as a touchscreen or touchpad 226, a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device.

The memory can also store content. The memory may, for example, store computer program code for an application and other computer programs. For example, in one embodiment of the present invention, the memory may store computer program code for displaying an image at a first display location on a display screen (e.g., display 216 or touchscreen 226). The memory may further store computer program code for receiving one or more tactile inputs at a first touch location (e.g., on touchscreen or touchpad 226) and detecting movement of the tactile inputs from the first touch location to a second touch location. The memory may further store computer program code for determining the number of tactile inputs detected, and translating the displayed image, such that the image is displayed at a second display location on the display screen, wherein the distance between the first and second display locations is based at least in part on the number of tactile inputs received.

In addition, as discussed in more detail below with regard to FIG. 5, according to another embodiment the memory may store computer program code for adjusting an adjustable feature based on a number of tactile inputs received. In a further embodiment, as discussed in more detail below with regard to FIG. 7, the memory may store computer program code for unlocking the electronic device based on the receipt of a predefined number of tactile inputs.

The apparatus, method and computer program product of embodiments of the present invention are primarily described in conjunction with mobile communications applications. It should be understood, however, that the apparatus, method and computer program product of embodiments of the present invention can be utilized in conjunction with a variety of other applications, both in the mobile communications industries and outside of the mobile communications industries. For example, the apparatus, method and computer program product of embodiments of the present invention can be utilized in conjunction with wireline and/or wireless network (e.g., Internet) applications.

### Method of Adjusting Speed of Movement of Displayed Image

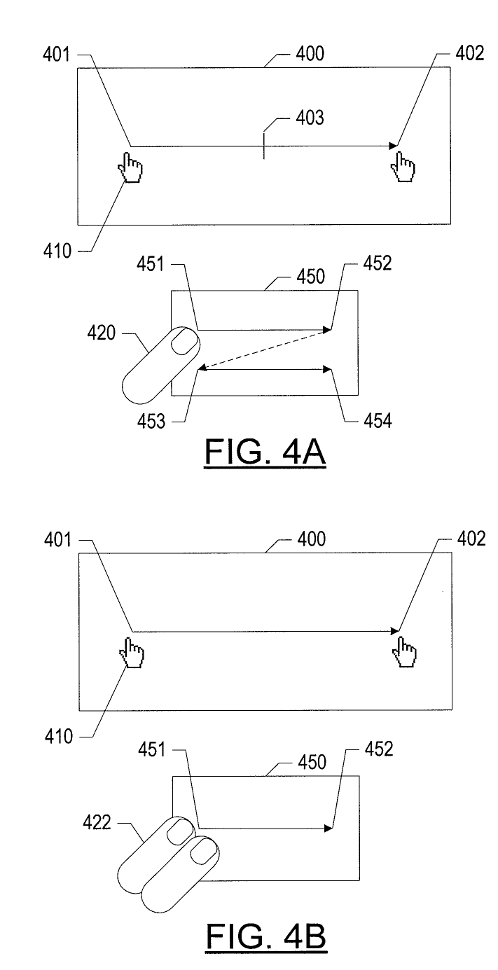

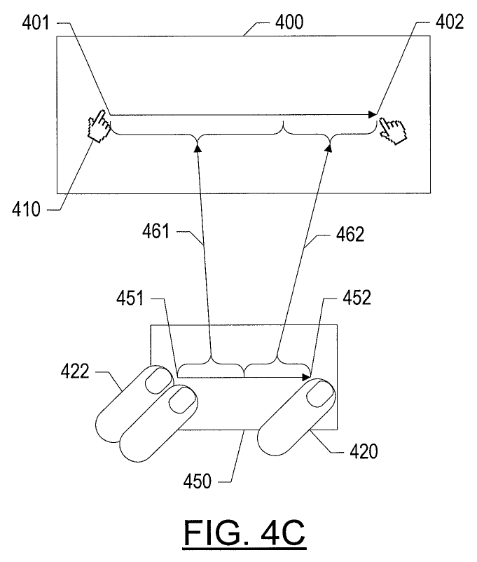

Referring now to FIGS. 3 through 4C, the operations are illustrated that may be taken in order to adjust the speed of movement of a displayed image in accordance with embodiments of the present invention. As shown in FIG. 3, the process may begin at Block 301 when the electronic device (e.g., cellular telephone, personal digital assistant (PDA), personal computer (PC), laptop, pager, etc.) and, in particular, a processor or similar means operating on the electronic device, displays an image on the electronic device display screen. In one embodiment, the image may represent a cursor, or a moving placement or pointer that indicates a position on the electronic device display screen. Alternatively, the image may comprise an icon, symbol or other representation associated with an object or file stored in memory on the electronic device.

At some point after the image has been displayed, the electronic device (e.g., processor or similar means operating on the electronic device) may, at Block 302, receive one or more tactile inputs associated with the selection of the displayed image. In one embodiment, the display screen on which the image is displayed may comprise a touch-sensitive display screen or touchscreen. In this embodiment, the one or more tactile inputs may be received via the touchscreen. In other words, a user may select the image by touching the touchscreen using one or more fingers, styluses, pens, pencils, or other selection objects, at or near the location at which the image is displayed. Alternatively, in another embodiment, the one or more tactile inputs may be received via a touch-sensitive input device, or touchpad, that is operating separately from the display screen.

In either embodiment, the electronic device (e.g., the processor or similar means operating on the electronic device) may detect the tactile input(s) and determine their locations via any number of techniques that are known to those of ordinary skill in the art. For example, the touchscreen or touchpad may comprise two layers that are held apart by spacers and have an electrical current running therebetween. When a user touches the touchscreen or touchpad, the two layers may make contact causing a change in the electrical current at the point of contact. The electronic device may note the change of the electrical current, as well as the coordinates of the point of contact. Alternatively, wherein the touchscreen or touchpad uses a capacitive, as opposed to a resistive, system to detect tactile input, the touchscreen or touchpad may comprise a layer storing electrical charge. When a user touches the touchscreen or touchpad, some of the charge from that layer is transferred to the user causing the charge on the capacitive layer to decrease. Circuits may be located at each corner of the touchscreen or touchpad that measure the decrease in charge, such that the exact location of the tactile input can be calculated based on the relative differences in charge measured at each corner. Embodiments of the present invention can employ other types of touchscreens or touchpads, such as a touchscreen or touchpad that is configured to enable touch recognition by any of resistive, capacitive, infrared, strain gauge, surface wave, optical imaging, dispersive signal technology, acoustic pulse recognition or other techniques, and to then provide signals indicative of the location of the touch.

The touchscreen or touchpad interface may be configured to receive an indication of an input in the form of a touch event at the touchscreen or touchpad. As suggested above, the touch event may be defined as an actual physical contact between a selection object (e.g., a finger, stylus, pen, pencil, or other pointing device) and the touchscreen or touchpad. Alternatively, a touch event may be defined as bringing the selection object in proximity to the touchscreen (e.g., where the touch-sensitive input device comprises a touchscreen (as opposed to a touchpad), hovering over a displayed object or approaching an object within a predefined distance).

The electronic device (e.g., processor or similar means operating on the electronic device) may further detect, at Block 303, movement of the one or more tactile inputs. In particular, once a user has selected the displayed image in the manner described above, in order to move the image on the display screen, the user may move his or her finger (or other selection object), while continuously applying pressure to the touchscreen or touchpad. The electronic device (e.g., processor or similar means) may detect this movement using any of the known techniques described above.

In response to detecting the tactile input(s) on the touchscreen or touchpad and the movement thereof, the electronic device and, in particular, the processor or similar means operating on the electronic device, may, at Block 304, determine the number of tactile inputs detected and then, at Block 305, move the displayed image on the electronic device display screen based on the detected movement of the tactile input(s) and the determined number of tactile inputs detected. While the foregoing describes the electronic device as first detecting the movement of the tactile inputs prior to determining the number of tactile inputs received, as one of ordinary skill in the art will recognize, embodiments of the present invention are not limited to this particular order of steps or events. In particular, in an alternative embodiment, the electronic device (e.g., processor or similar means operating on the electronic device) may determine the number of tactile inputs received immediately upon the user touching the electronic device touchscreen or touchpad and prior to the user moving his or her finger (or other selection object) and, therefore, prior to the electronic device detecting the movement.

According to one embodiment the distance that the displayed image is moved on the electronic device display screen may be proportional to the number of tactile inputs detected. In particular, in one embodiment, the distance between the first location at which the image is displayed (the “first display location”) and the location to which the displayed image is moved (the “second display location”) may be equal to a multiple of the product of the distance between the location at which the tactile input(s) are detected (the “first touch location”) and the location to which the tactile input(s) are moved (the “second touch location”) multiplied by the number of tactile inputs detected.

To illustrate, reference is made to FIGS. 4A and 4B, which illustrate the movement of a cursor 410 on a display screen 400 based on the movement of a user's one finger 420 or two fingers 422, respectively, on an electronic device touchpad 450. As shown in FIG. 4A, in order for the user to move the displayed cursor 410 from the first display location 401 on the device display screen 400 to the second display location 402 using one finger 420, or similar selection object, the user may be required to make two gestures on the electronic device touchpad 450. In particular, the user may first place his or her finger 420 on the electronic device touchpad 450 at the first touch location 451, and then move his or her finger 420 across the touchpad 450 to a second touch location 452. As a result of this movement, the electronic device (e.g., processor or similar means) may translate the displayed cursor 410, such that the cursor 410 is now displayed at an intermediate display location 403 between the first display location and the desired second display location 402. In order to then move the cursor 410 the remaining distance to the second display location 402, the user may need to again touch the touchpad 450 at or near the first touch location, referred to as the third touch location 453, and again move his or her finger 420 across the touchpad to a location at or near the second touch location, referred to as the fourth touch location 454. In this embodiment, when the user moves his or her single finger, or other similar selection device, for example, one inch across the touchpad, the electronic device (e.g., processor or similar means) may respond to this gesture by moving the displayed cursor, for example, five inches across the display screen (or five times the distance between the first and second touch locations multiplied by the number of tactile inputs, or one) in roughly the same direction. In order to move the cursor ten inches, the user must repeat the one inch movement.

However, according to one embodiment of the present invention, shown in FIG. 4B, if the user were to use two fingers 422, or similar selection objects, he or she may only be required to move his or her fingers 422 across the touchpad 450 once (e.g., one inch) in order to move the displayed cursor 410 the same distance (e.g., ten inches). In particular, when the user uses two fingers 422 to provide a tactile input at the first touch location 451 and to then move the tactile input to the second touch location 452, the electronic device may translate the displayed cursor, such that the cursor is moved from the first display location 401 all the way to the second display location 402. Continuing with the above example, in this instance where the user moves two of his or her fingers (or similar selection objects) one inch across the touchpad, the electronic device (e.g., processor or similar means) may respond to this gesture by moving the displayed cursor, for example, ten inches (instead of only five) across the display screen (or five times the distance between the first and second touch locations multiplied by the number of tactile inputs, or two) in roughly the same direction. As can be seen, according to embodiments of the invention, the distance between the first and second display locations may, therefore, be proportionate to the number of fingers, or other selection objects, used to provide the tactile input(s) and movement thereof. While the above refers to the use of only one and two fingers, or other selection objects, as one of ordinary skill in the art will recognize, a similar result may occur when a user uses three, four, five, or more fingers, or other selection objects, wherein the distance moved by the displayed cursor continues to increase proportionately depending upon the number of fingers, or other selection objects, used.

As shown in FIG. 4C, the user can use this embodiment of the present invention to choose between coarse movements of a displayed image 461, which occur when a user uses more fingers, or similar selection objects, and fine movements 462, which occur when the user uses only one.

### Method of Adjusting Features/Parameters of Electronic Device

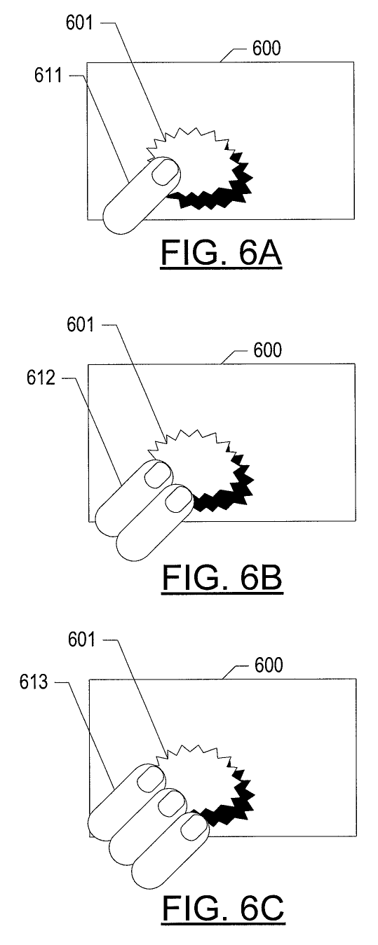

Referring now to FIGS. 5 through 6C, the operations are illustrated that may be taken in order to adjust a feature or parameter of the electronic device using varying numbers of tactile inputs in accordance with another embodiment of the present invention. As shown in FIG. 5, this process may begin at Block 501 when the electronic device (e.g., processor or similar means operating on the electronic device) displays an icon representing an adjustable feature or parameter of the electronic device. This feature or parameter may include, for example, the volume of the electronic device, the brightness, zoom level, or other feature associated with the electronic device display screen, just to name a few. As one of ordinary skill in the art will recognize, the displayed icon may represent any adjustable feature or parameter associated with the electronic device. As such, the foregoing examples are provided for exemplary purposes only and should not be taken in any way as limiting the scope of embodiments of the present invention.

When the user wishes to adjust the feature or parameter represented by the icon (e.g., change the volume, brightness, zoom level, etc. associated with the electronic device), he or she may select the icon using a number of selection objects (e.g., fingers, styluses, pens, pencils, etc.) that corresponds to the adjustment specific they desire to make. For example, placing one finger, or similar selection object, on a volume icon may result in a decrease in the volume, while placing two fingers may result in an increase, and the placement of three may result in turning the volume mute on or off. The electronic device and, in particular, the processor or similar means operating on the electronic device, may, at Block 502, detect these tactile input(s) at or near the location at which the icon is displayed using any of the known techniques discussed above with regard to FIG. 3. Once detected, the electronic device (e.g., processor or similar means) may determine the number of tactile inputs detected (at Block 503), and then use this information to adjust the feature or parameter represented by the icon (at Block 504). In particular, according to one embodiment, the electronic device (e.g., processor or similar means) may access a database or listing of each adjustable feature or parameter and the action corresponding to each possible number of detected tactile inputs supported by the electronic device. FIGS. 6A, 6B and 6C illustrate the use of one 611, two 612 and three 613 fingers, respectively, in order to select the icon 601 displayed on the electronic device display screen 600. By using varying numbers of tactile inputs to adjust a feature or parameter of the electronic device, embodiments of the present invention may reduce the number of steps a user is required to take, as well as the number of sub-icons and images that are required to be displayed during this process.

### Method of Unlocking an Electronic Device

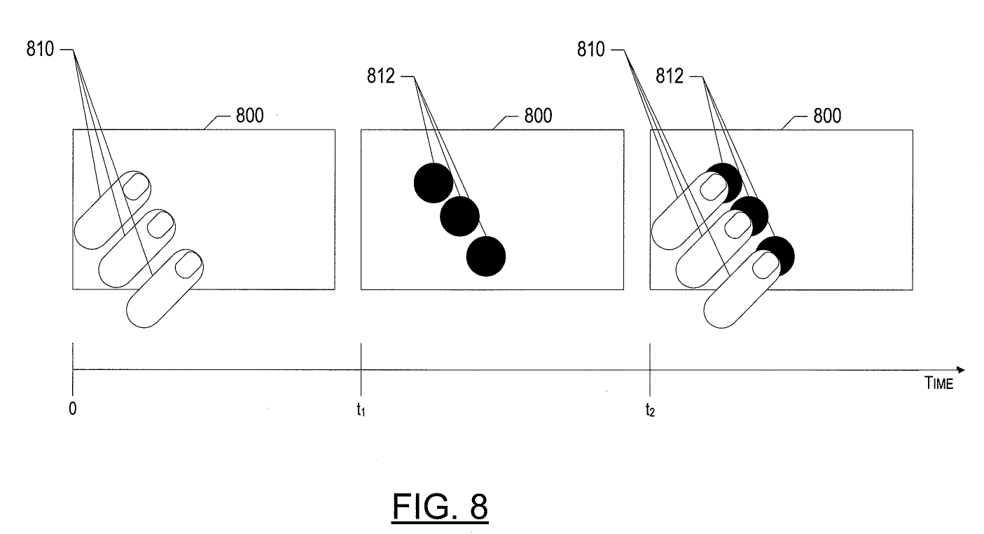

Referring now to FIGS. 7 and 8, the operations are illustrated that may be taken in order to unlock an electronic device using a predefined number of tactile inputs in accordance with an embodiment of the present invention. As shown, the process may begin at Block 701, when an electronic device and, in particular, a processor or similar means operating on the electronic device, locks the electronic device, or prevents the input devices (e.g., the keypad, touchscreen, touchpad, etc.) associated with the electronic device from being used. At some point thereafter, a user may desire to unlock and use the electronic device. In order to do so, in accordance with an embodiment of the present invention, the user may place a predefined number of fingers, or similar selection objects, on the electronic device touchscreen. The electronic device (e.g., processor or similar means) may receive these tactile inputs (at Block 702) using any of the known techniques described above with reference to FIG. 3. Upon receiving the tactile input(s), the electronic device (e.g., processor or similar means) may, at Block 703, determine the number of tactile input(s) received.

It may then be determined, at Block 704, whether the number of tactile inputs received is the same as a user-defined number of tactile inputs necessary to unlock the electronic device. In other words, according to one embodiment, a user may specify how many tactile inputs are necessary in order to unlock the electronic device. Once defined, the electronic device (e.g., processor or similar means) need only compare the number of received tactile inputs to the user-defined number required in order to determine, for example, whether an authorized person is interested in unlocking the electronic device, the electronic device touchscreen has been inadvertently contacted, or an unauthorized person has attempted to unlock the device using an incorrect number of tactile inputs.

If it is determined, at Block 704, that the number of tactile inputs detected is not equal to the predefined number required to unlock the electronic device, the electronic device (e.g., processor or similar means operating on the electronic device) may assume, as described above, that the electronic device touchscreen has been inadvertently contacted and/or that the person touching the electronic device touchscreen is not authorized to unlock the device. As a result, the electronic device (e.g., processor or similar means) may do nothing, or end the process (at Block 712). If, on the other hand the number of tactile inputs does match the pre-defined number of tactile inputs required, the electronic device (e.g., processor or similar means operating on the electronic device) may, at Block 705, determine the location of each of the tactile inputs received and then, at Block 706, display an image or icon at each of the determined locations.

If the user is genuinely interested in unlocking the electronic device, he or she may, at this point, touch the electronic device touchscreen (e.g., using a finger, pen, stylus, pencil, or other selection device) at or near the location at which each icon is displayed. The electronic device (e.g., processor or similar means operating on the electronic device) may receive or detect these new tactile inputs (at Block 707), determine the location associated with each tactile input (at Block 708), and then determine whether each new tactile input is at or near the location of one of the displayed icons, and further that each icon has been touched (or otherwise selected) by one of the fingers, or similar selection objects (at Block 709). If not (i.e., if the locations of the tactile inputs do not coincide with the locations of the displayed icons and/or one or more of the icons are not being touched), the electronic device may do nothing and the process may end (at Block 712). Alternatively, if each icon has been touched by a finger, or similar selection object, the electronic device (e.g., processor or similar means) may, at Block 710, unlock the electronic device and, in particular, the input devices of the electronic device.

FIG. 8 provides a timeline of the unlocking mechanism of embodiments of the present invention. As shown, in this example, the user may place three fingers 810 on the electronic device touchscreen 800 at time zero. In response, the electronic device (e.g., processor or similar means) may, at time t₁, display an icon 812 associated with each finger 810 at or near the location at which the finger 810 contacted the touchscreen 800. The user may then, at time t₂, place his or her three fingers 810 at or near the location at which the icons 812 are displayed. In response to these new tactile inputs, the electronic device may unlock.

As one of ordinary skill in the art will recognize, the foregoing provides only one example of how multiple tactile inputs may be used to unlock the electronic device. Other similar techniques may likewise be used without departing from the spirit and scope of embodiments of the present invention. For example, in one embodiment, the user may further pre-define specific locations at which the predefined number of tactile inputs must be received in order to unlock the electronic device. In this embodiment, when the electronic device (e.g., processor or similar means) receives the predefined number of tactile inputs and determines that the inputs are at or near the predefined locations, the electronic device (e.g., processor or similar means) may automatically unlock the electronic device without displaying icons (as at Block 706) and/or requiring the user to again touch the touchscreen at or near the displayed icons (as at Block 707).

### Conclusion:

As described above and as will be appreciated by one skilled in the art, embodiments of the present invention may be configured as an apparatus and. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 110 discussed above with reference to FIG. 1 and/or processor 208 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmrable data processing apparatus (e.g., processor 110 of FIG. 1 and/or processor 208 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a processor configured to:
cause an image to be displayed at a first display location;
receive one or more tactile inputs at a first touch location;
detect a movement of the one or more tactile inputs from the first touch location to a second touch location;
determine the number of tactile inputs received; and
translate the image displayed, such that the image is displayed at a second display location, wherein a distance between the first and second display locations is determined based at least in part on the determined number of tactile inputs received.

2. The apparatus of claim 1, wherein the distance between the first and second display locations is proportional to the number of tactile inputs received.

3. The apparatus of claim 1, wherein the distance between the first and second display locations is further determined based at least in part on a distance between the first and second touch locations.

4. The apparatus of claim 3, wherein the distance between the first and second display locations is equal to a multiple of the product of the distance between the first and second touch locations multiplied by the number of tactile inputs received.

5. The apparatus of claim 1, wherein in order to receive one or more tactile inputs, the processor is further configured to receive the one or more tactile inputs at the first touch location on a touch-sensitive input device in electronic communication with the processor.

6. The apparatus of claim 5, wherein in order to cause an image to be displayed, the processor is further configured to cause the image to be displayed at the first display location on a display screen that is separate from the touch-sensitive input device and is further in electronic communication with the processor.

7. The apparatus of claim 5, wherein the touch-sensitive input device comprises a touch-sensitive display screen.

8. The apparatus of claim 7, wherein in order to cause an image to be displayed, the processor is further configured to cause the image to be displayed at the first display location on the touch-sensitive display screen, said first display location proximate the first touch location.

9. A method comprising:
displaying an image at a first display location;
receiving one or more tactile inputs at a first touch location;
detecting a movement of the one or more tactile inputs from the first touch location to a second touch location;
determining the number of tactile inputs received; and
translating the image displayed, such that the image is displayed at a second display location, wherein a distance between the first and second display locations is determined based at least in part on the determined number of tactile inputs received.

10. The method of claim 9, wherein the distance between the first and second display locations is proportional to the number of tactile inputs received.

11. The method of claim 9, wherein the distance between the first and second display locations is further determined based at least in part on a distance between the first and second touch locations.

12. The method of claim 11, wherein the distance between the first and second display locations is equal to a multiple of the product of the distance between the first and second touch locations multiplied by the number of tactile inputs received.

13. The method of claim 9, wherein receiving one or more tactile inputs further comprises receiving the one or more tactile inputs at the first touch location on a touch-sensitive input device.

14. The method of claim 13, wherein displaying an image further comprises displaying the image at the first display location on a display screen that is separate from the touch-sensitive input device.

15. The method of claim 13, wherein the touch-sensitive input device comprises a touch-sensitive display screen.

16. The method of claim 15, wherein displaying an image further comprises displaying the image at the first display location on the touch-sensitive display screen, said first display location proximate the first touch location.

17. A computer program product comprising at least one computer-readable storage medium having computer-readable program code portions stored therein, the computer-readable program code portions comprising:
a first executable portion for causing an image to be displayed at a first display location;
a second executable portion receiving one or more tactile inputs at a first touch location;
a third executable portion detecting a movement of the one or more tactile inputs from the first touch location to a second touch location;
a fourth executable portion determining the number of tactile inputs detected; and
a fifth executable portion translating the image displayed, such that the image is displayed at a second display location, wherein a distance between the first and second display locations is determined based at least in part on the determined number of tactile inputs received.

18. The computer program product of claim 17, wherein the distance between the first and second display locations is proportional to the number of tactile inputs received.

19. The computer program product of claim 17, wherein the distance between the first and second display locations is further determined based at least in part on a distance between the first and second touch locations.

20. The computer program product of claim 19, wherein the distance between the first and second display locations is equal to a multiple of the product of the distance between the first and second touch locations multiplied by the number of tactile inputs received.

21. The computer program product of claim 17, wherein the fifth executable portion is configured to receive the one or more tactile inputs at the first touch location on a touch-sensitive input device.

22. The computer program product of claim 21, wherein the first executable portion is configured to cause the image to be displayed at the first display location on a display screen that is separate from the touch-sensitive input device.

23. The computer program product of claim 21, wherein the touch-sensitive input device comprises a touch-sensitive display screen.

24. The computer program product of claim 23, wherein the first executable portion is configured to cause the image to be displayed at the first display location on the touch-sensitive display screen, said first display location proximate the first touch location.

25. An apparatus comprising:
means for causing an image to be displayed at a first display location;
means for receiving one or more tactile inputs at a first touch location;
means for detecting a movement of the one or more tactile inputs from the first touch location to a second touch location;
means for determining the number of tactile inputs detected; and
means for translating the image displayed, such that the image is displayed at a second display location, wherein a distance between the first and second display locations is determined based at least in part on the determined number of tactile inputs received.
